(19) United States
(12) Patent Application Publication
(10) Pub. No.: US 2020/0294035 A1
(43) Pub. Date: Sep. 17, 2020

(54) PAYMENT SYSTEM USING VIRTUAL MONEY

(71) Applicants: Wook Tae KANG, Seongnam-si (KR); Sung Hwa RYU, Gimpo-si (KR)

(72) Inventors: Wook Tae KANG, Seongnam-si (KR); Sung Hwa RYU, Gimpo-si (KR)

(21) Appl. No.: 16/759,450

(22) PCT Filed: Oct. 25, 2018
(86) PCT No.: PCT/KR2018/012686

§ 371 Date: Apr. 27, 2020

(30) Foreign Application Priority Data
Oct. 27, 2017 (KR) 10-2017-0140720
Oct. 22, 2018 (KR) 10-2018-0126232

(51) Int. Cl. G06Q 20/38; G06Q 20/36

(52) U.S. Cl. CPC G06Q 20/381; G06Q 2220/00; G06Q 20/3676; G06Q 20/3678

(57) ABSTRACT

Provided is a payment system using virtual money. The payment system includes: a transaction server for managing floating exchange rate money and fixed exchange rate money; and an exchange server for exchanging floating exchange rate money for fixed exchange rate money, whereby a payment system can provide users with fixed exchange rate money which is virtual money, the exchange rate of which is fixed against cash.

### TECHNICAL FIELD

The present invention relates to a payment system using virtual money, and more particularly, to a payment system using virtual money including a transaction server and an exchange server.

### BACKGROUND ART

In general, e-money is divided into a plastic card type having a built-in IC chip and a network type existing in a computer in the form of information. The virtual money means a network type e-money. The virtual money is different from general money issued by governments or their central banks in various countries, is valued on the basis of rules made by a person who first thought of the virtual money, and is distributed on the premise that the virtual money can be exchanged with the actual money.

The virtual money does not need the storage cost since being stored in a hard disk of a computer and has an excellent function as a store of value since there is no risk of theft or loss. Recently, many people use and buy virtual money for investment purpose.

However, the virtual money has instability of value since not being tied to real cash or currency due to its fixed value. That is, the value of the virtual money is fixed, but if the value of ready money tumbles or soars, an exchange rate between the virtual money and ready money may tumble or soar, and it may cause virtual money holders unavoidable damages.

Furthermore, because the virtual money uses blockchain technology in order to guarantee security, it takes quite some time to transfer the virtual money, so it is difficult to actually use the virtual money in transaction offline.

Therefore, people need technology to solve the above problems.

In the meantime, the above-mentioned background art is not the known technology disclosed to the public before application of the present invention since being technical know-how that the inventor of the present invention has held in order to deduce the present invention or has obtained during deduction of the present invention.

### DISCLOSURE

### Technical Problem

Accordingly, the present invention has been made in an effort to solve the above-mentioned problems occurring in the prior arts, and it is an object of the present invention to provide a payment system using virtual money.

### Technical Solution

To achieve the above objects, the present invention provides a payment system using virtual money including: a transaction server for managing floating exchange rate money and fixed exchange rate money; and an exchange server for exchanging floating exchange rate money for fixed exchange rate money, thereby providing users with fixed exchange rate money which is virtual money with the exchange rate fixed against cash.

### Advantageous Effects

The payment system using virtual money according to an embodiment of the present invention includes the transaction server and the exchange server to users with fixed exchange rate money which is virtual money with the exchange rate fixed against cash.

The payment system using virtual money according to an embodiment of the present invention can prevent the sudden rise and collapse of the value so that the users using the payment system can hold fixed exchange rate currencies without instability on the exchange rate, since the fixed exchange rate money is virtual money with the exchange rate fixed against cash.

The effects of the present invention are not limited to the above-mentioned effects and further effects not described above will be clearly understood by those skilled in the art.

### DESCRIPTION OF DRAWINGS

FIG. 1 is a view showing a configuration of a payment system using virtual money according to an embodiment of the present invention.

FIG. 2 is a block diagram showing an internal configuration of a payment server included in the payment system using virtual money according to the embodiment of the present invention.

FIG. 3 is a block diagram showing an internal configuration of an exchange server included in the payment system using virtual money according to the embodiment of the present invention.

FIG. 4 is a view showing the principle that a user saves fixed exchange rate money through the payment system using virtual money according to the embodiment of the present invention.

FIG. 5 is a view showing the principle that a user saves floating exchange rate money through the payment system using virtual money according to the embodiment of the present invention.

FIG. 6 is a view showing the principle that the floating exchange rate money and the fixed exchange rate money exchanged through a plurality of exchange servers are displayed through buyer wallets and user wallets.

### MODE FOR INVENTION

Hereinafter, the embodiments of the present disclosure will be described in detail with reference to accompanying drawings so that the embodiments may be easily implemented by those skilled in the art. However, the present disclosure may be implemented in various ways without being limited to the embodiments. In addition, in the drawings, well-known elements or components may be omitted to avoid unnecessarily obscuring the presented embodiments, and like reference numerals denote like elements throughout the specification.

Throughout this specification, when a part is referred to as being “connected” to another part, this includes “direct connection” and “indirect connection” via an intervening part. Also, when a certain part “includes” a certain component, other components are not excluded unless explicitly described otherwise, and other components may in fact be included.

Terms used in the present invention will be described before the present invention is described.

When elements in the drawings are denoted by reference numerals, like elements are denoted by like reference numerals although the elements are in different drawings, and it is noted in advance that elements in different drawings are quoted in a case where description of corresponding drawings is needed. Hereinafter, a payment system using virtual money according to embodiments of the present invention will be described in detail with reference to the exemplary drawings.

Hereinafter, the embodiments of the present disclosure will be described in detail with reference to accompanying drawings so that the embodiments may be easily implemented by those skilled in the art. However, the present disclosure may be implemented in various ways without being limited to the embodiments. In addition, in the drawings, well-known elements or components may be omitted to avoid unnecessarily obscuring the presented embodiments, and like reference numerals denote like elements throughout the specification.

Throughout this specification, when a part is referred to as being “connected” to another part, this includes “direct connection” and “indirect connection” via an intervening part. Also, when a certain part “includes” a certain component, other components are not excluded unless explicitly described otherwise, and other components may in fact be included.

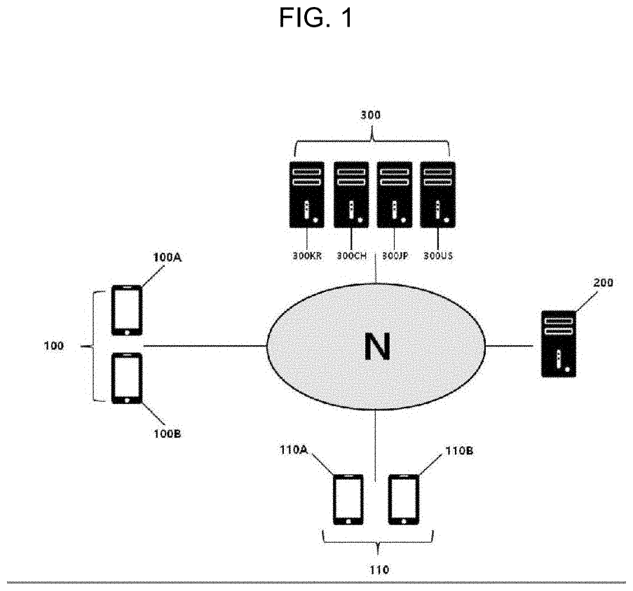

First, referring to FIG. 1, a configuration of the payment system using virtual money according to the present invention will be described in detail.

As shown in FIG. 1, the payment system using virtual money according to the present invention includes a plurality of user terminals 100 and 110, a transaction server 200, and an exchange server 300 which are connected with one another through a network (N).

Here, the network (N) may be wire and wireless networks of all kinds, such as a local area network (LAN), a wide area network (WAN), a value added network (VAN), a personal area network (PAN), a mobile radio communication network, and a satellite communication network.

Moreover, the user terminals 100 and 110 may connect to a server at a remote place through a network (N) or may be a computer, a portable terminal or a television set connectable with another terminal and a server. Here, the computer includes, for instance, a notebook computer, a desktop or a laptop in which a WEB browser is mounted. The portable terminal includes a handheld-based wireless communication device of all kinds, such as a personal communication system (PCS), a global system for mobile communications (GSM), a personal digital cellular (PDC), a personal handyphone system (PHS), personal digital assistant (PDA), an international mobile telecommunication 2000 (IMT-2000), code division multiple access 2000 (CDMA-2000), a w-code division multiple access (W-CDMA), a wireless broadband internet (Wibro) terminal, and a smart phone. Moreover, the television set includes an internet protocol television (IPTV), an internet TV, a ground wave TV, or a cable TV.

If the user terminals 100 and 110 are the portable terminal, such as the smart phone, an application for providing the payment system and a payment method according to the embodiment of the present invention may be installed in the portable terminal. If the user terminals are general personal computers, the computers connect to an online market site through an WEB browser and receive webpage type services.

The user terminals 100 and 110 may be divided into a buyer terminal 100 and a seller terminal 110. In this instance, a seller may be a person who wants to supply goods or services, and a buyer may be a person who wants to buy corresponding goods or services.

Hereinafter, the seller may be not only offline sellers but also online sellers. In case of the online seller, the seller terminal 110 may be an online seller server. In this instance, products sold by the seller may be prescribed goods or prescribed services.

Furthermore, the transaction server 200 is a computer capable of communicating with another server or a terminal at a remote place through the network (N), and provides a virtual market to transact virtual money (including fixed exchange rate money and floating exchange rate money) in response to a request of the plurality of user terminals 100 and 110. In this instance, all users may be buyers and sellers in a market provided by the transaction server 200. So, there is no need to perform additional procedures for being distinguished from general buyers to be registered as a seller.

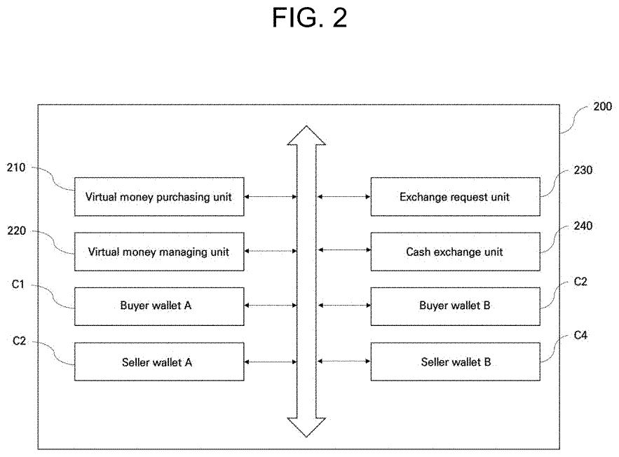

Hereinafter, referring to FIG. 2, an internal configuration of a payment server included in the payment system using virtual money according to the embodiment of the present invention will be described.

FIG. 2 is a block diagram showing an internal configuration of a payment server included in the payment system using virtual money according to the embodiment of the present invention.

As shown in FIG. 2, the transaction server 200 includes: a virtual money purchasing unit 210 for getting setting of a purchase request signal, such as kinds, amounts and others of virtual money to be purchased, from the buyer terminal 100 and for purchasing floating exchange rate money from a virtual currency exchange depending on the purchase request signal; a virtual money managing unit 220 for saving and managing floating exchange rate money and fixed exchange rate money, which a user holds, in a buyer wallet; and an exchange request unit 230 for receiving an exchange request signal including a desired exchange amount from the user terminals 100 and 110 and transferring the received exchange request to the exchange server 300 in order to broke exchange.

Additionally, the transaction server 200 is allocated and saves buyer wallets (C1 and C2) corresponding to the buyer terminal 100. For instance, the transaction server 200 is allocated and saves the buyer wallet A (C1) corresponding to a buyer terminal 100A and is allocated and saves the buyer wallet B (C2) corresponding to a buyer terminal 100B. As described above, the transaction server 200 is allocated and saves a unique buyer wallet for each buyer terminal 100.

Moreover, the transaction server 200 is allocated and saves seller wallets (C3 and C4) corresponding to the seller terminal 100. For instance, the transaction server 200 is allocated and saves the seller wallet A (C3) corresponding to a seller terminal 110A, and is allocated and saves the seller wallet B (C4) corresponding to a seller terminal 110B. As described, the transaction server 200 is allocated and saves a unique seller wallet (C4) for each seller terminal 100.

Furthermore, the transaction server 200 can add a payable amount to the buyer wallet (C) allocated for each buyer terminal. That is, the user of the user terminal 110 can add payable amount to the allocated wallet.

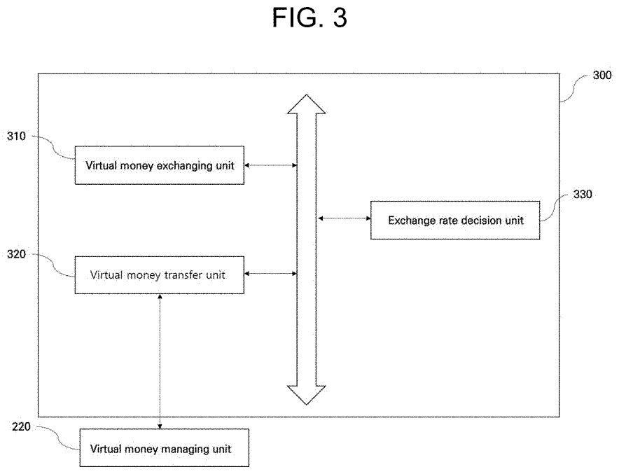

Hereinafter, referring to FIG. 3, an internal configuration of the exchange server 300 included in the payment system using virtual money according to the embodiment of the present invention will be described.

FIG. 3 is a block diagram showing an internal configuration of an exchange server included in the payment system using virtual money according to the embodiment of the present invention.

As shown in FIG. 3, the exchange server 300 includes: a virtual money exchanging unit 310 which receives an exchange request signal from the transaction server 200 and exchanges the floating exchange rate money for the fixed exchange rate money on the basis of an amount included in the exchange request signal; a virtual money transfer unit 320 for transferring the fixed exchange rate money exchanged by the virtual money exchanging unit 310 to the virtual money managing unit 220; and an exchange rate decision unit 330 which receives an exchange rate between the floating exchange rate money and the fixed exchange rate money.

In the present invention, the exchange rate means an exchange rate between predetermined currencies. In this instance, the fixed exchange rate money means virtual money of which the exchange rate is fixed against cash by a predetermined criterion, and the floating exchange rate money means virtual money of which the exchange rate is continuously varied against cash (on the basis of demand and supply).

In the present invention, the virtual currency exchange (M) is a market where a competitive trading of virtual money is made between a plurality of sellers and a plurality of buyers, and for instance, there is a “Bitcoin Exchange”. In other words, the virtual currency exchange (M) is the market to buy and sell virtual money at a market value by the plurality of buyers and sellers like a stock market.

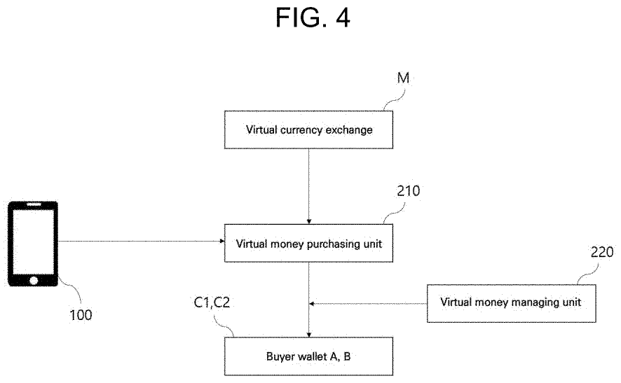

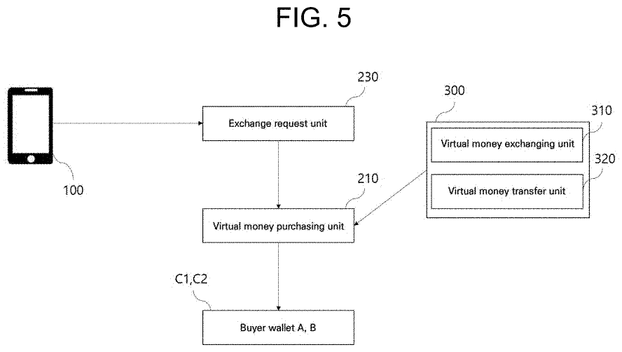

Referring to FIGS. 4 and 5, it will be described how a buyer holds and uses fixed exchange rate money through the payment system including the transaction server 200 and the exchange server 300.

FIG. 4 is a view showing the principle that a user saves fixed exchange rate money through the payment system using virtual money according to the embodiment of the present invention, and FIG. 5 is a view showing the principle that a user saves floating exchange rate money through the payment system using virtual money according to the embodiment of the present invention.

First, the buyer terminal 100 can buy the floating exchange rate money through the transaction server 200 on the basis of the user's input. In detail, the virtual money purchasing unit 210 receives selling request signals including the present exchange rate, kinds and amounts of the floating exchange rate money, which has been requested in selling from the virtual currency exchange (M), and transfers the received information toward the buyer terminal 100. The buyer terminal 100 sends a purchase request signal corresponding to any one of selling request signals to the virtual money purchasing unit 210 based on the user's input, and the virtual money purchasing unit 210 can buy floating exchange rate money corresponding to the relevant purchasing request signal.

The virtual money managing unit 220 can save the floating exchange rate money equivalent to the amount bought by the buyer in the buyer wallets (C1 and C2). For instance, assuming that an exchange rate between cash and floating exchange rate money is 1:100, if it is instructed through the buyer terminal 100 to buy the floating exchange rate money equivalent to KR [symbol] 100,000 won (purchase request signal: floating exchange rate money equivalent to KR [symbol] 100,000 won), the buyer terminal 100 instruct the transaction server to buy 1000TOS (hereinafter, TOS is a unit of floating exchange rate money), and the virtual money purchasing unit 210 of the transaction server 200 buys the floating exchange rate money equivalent to 1000TOS on the virtual currency exchange (M). In this instance, the virtual money managing part 220 saves the purchased floating exchange rate money 1000 TOS in the buyer wallet (C). In the above example, how to buy floating exchange rate money in cash is described, but it is just an example, and floating exchange rate money may be purchased in various ways, such as gift cards, barcodes, pin codes, and others.

However, the market price of the floating exchange rate money is changed in real time as described above, whereby buyers may avoid making payment of goods and services in floating exchange rate money.

So, the buyers may request to request conversion of the floating exchange rate money into fixed exchange rate money to the exchange request unit 230 through the buyer terminal 100. Based on the request of the buyer terminal 100, the exchange request unit 230 of the transaction server 200 can request to change the floating exchange rate money into the fixed exchange rate money to the exchange server 300, and the virtual money exchanging unit 310 of the exchange server 300 can convert the floating exchange rate money into the fixed exchange rate money based on a predetermined exchange rate between the floating exchange rate money and the fixed exchange rate money. In this instance, the converted fixed exchange rate money is transferred to the transaction server 200 by the virtual money transfer unit 320, and the exchange rate is determined by the exchange rate decision unit 330.

In more detail, the exchange rate between the fixed exchange rate money and the floating exchange rate money can be determined by the exchange rate decision unit 330. In this instance, the virtual money exchanging unit 310 can exchange between the fixed exchange rate money and the floating exchange rate money on the basis of the corresponding exchange rate. In this instance, the exchange rate may be previously determined, or may be determined based on an exchange rate between the floating exchange rate money and cash.

For instance, in case that the user needs 5000TOSP, if the exchange rate decision unit 330 determined that the exchange rate between the fixed exchange rate money and the floating exchange rate money is 1:10, the virtual money exchanging unit 310 receives 500TOS from the buyer terminal 100, changes it to 5000TOSP, and then, transfers it to the transaction server 200.

The floating exchange rate money 1000TOS of the buyer is saved in the buyer wallet (C).

If goods or services that the buyer wants to buy KR [symbol] 5,000 won and it is determined that an exchange rate between the fixed exchange rate money and the floating exchange rate money is 1:10 and an exchange rate between cash and the fixed exchange rate money is 1:1, the exchange request unit 230 may request the exchange server 300 to change 500TOS into 5000TOSP (hereinafter, TOSP is a unit of the floating exchange rate money).

If buyers think safety is important, a manager directly determines an exchange rate and inputs it into the exchange rate decision unit 330. If sellers want to partly change the value of fixed exchange rate money, namely, if they want to invest in the fixed exchange rate money without any risk, the exchange rate decision unit 330 may determine the exchange rate in link with the exchange rate between the floating exchange rate money and cash at a predetermined rate.

For instance, the exchange rate decision unit 330 may determine that the exchange rate between the floating exchange rate money and the fixed exchange rate money becomes 1:10. However, the exchange rate decision unit 330 may be set to determine the exchange rate between the floating exchange rate money and the fixed exchange rate money to be a tenth part of the exchange rate between the floating exchange rate money and cash. If the exchange rate between the floating exchange rate and cash is 1:100, the exchange rate between the floating exchange rate money and the fixed exchange rate money may be 1:10.

Even though the exchange rate is inputted into the exchange rate decision unit 330, because it is not unchangeable, the exchange rate may be changed on a predetermined cycle. For example, if the exchange rate between the floating exchange rate money and the fixed exchange rate money is 1:10, the manager may change the exchange rate once a month or every six months, or may determine the cycle that the exchange rate is changed after consultation with sellers.

In this instance, the virtual money managing unit 220 deducts the floating exchange rate money as much as the amount of the floating exchange rate money, which was requested in exchange, from the buyer wallets (C1 and C2), and saves the fixed exchange rate money in the buyer wallets (C1 and C2) as much as the amount of the fixed exchange rate money received from the exchange server 300. In the above-mentioned example, the virtual money managing unit 220 deducts 500TOS of the floating exchange rate money saved in the buyer wallets (C1 and C2) and saves 5000TOSP in the buyer wallets (C1 and C2).

In the meantime, the seller may receive the fixed exchange rate money from the buyer wallets (C1 and C2) while providing goods and services.

The buyer terminal 100 checks methods of payment of the seller who purchased goods, and requests the transaction server 200 to perform payment through the checked payment method. For instance, if the payment method of the seller who sold goods is a barcode, the buyer terminal 100 allows the seller who sold goods to perform payment using the barcode including information of the buyer wallets (C1 and C2).

Users of the present invention may perform payment in various ways, such as a barcode, a pin code, a gift card, and others.

In detail, when the seller sells good and services, the seller terminal 110 can receive price of sold goods and services in fixed exchange rate money. When the buyer terminal 110 proposes a payment method, the seller terminal 110 can receive the fixed exchange rate money from the buyer wallet (C) using the corresponding payment method. Hereinafter, the payment will be described.

In general, offline sellers can make payment using various payment methods. For example, an offline seller can make payment using a barcode or an RFID tag. For example, if a buyer makes payment using a barcode, the buyer terminal 100 outputs a barcode including information of the buyer wallets (C1 and C2), and the seller terminal 110 performs payment using the barcode.

If payment starts, the seller terminal 100 transfers a payment request signal to the transaction server 200. The payment request signal includes information of the buyer wallets (C1 and C2) and information of the payment amount. The virtual money managing unit 220 deducts the fixed exchange rate money as much as the corresponding amount from the buyer wallets (C1 and C2) and saves the fixed exchange rate money as much as the corresponding amount in the seller wallets (C3 and C4) when receiving the payment request signal.

For instance, when a buyer buys goods of KRY 5,000 won and the exchange rate between fixed exchange rate money and cash is 1:10, the seller terminal 100 transfers a payment request signal to the transaction server. The virtual money managing unit 220 deducts 500TOSP from the buyer wallets (C1 and C2) and saves 500TOSP in the seller wallets (C3 and C4).

As described above, when payment is performed using the fixed exchange rate money saved in the buyer wallets (C1 and C2), it has lots of merits differently from payment using the conventional floating exchange rate money. For instance, the floating exchange rate money is changed in value in real time, but the fixed exchange rate money is not changed in value, so as to raise transaction safety in transaction using the fixed exchange rate money.

Moreover, because the fixed exchange rate money holds only the amount for the user's offline payment, even though there is hacking, relatively little money is robbed, and it takes less time than the conventional virtual money. In other words, the conventional virtual money takes lots of time due to complicated procedures when being transferred to another person. However, the fixed exchange rate money can reduce time consumption since it does not need the procedure of blockchain release.

In the meantime, sellers have to exchange their own fixed exchange rate money for cash, and for this, the transaction server 200 includes a cash exchange unit 240.

As described above, the fixed exchange rate money is not changed in market price in real time differently from the floating exchange rate money. However, if the exchange rate between the fixed exchange rate money and the floating exchange rate money is changed severely, the exchange rate between cash and the fixed exchange rate money may be changed.

The seller terminal 110 may transfer a selling request signal including an amount of fixed exchange rate money to be sold toward the transaction server 200. When the transaction server 200 receives the selling request signal, the cash exchange unit 240 buys fixed exchange rate money. The cash exchange unit 240 exchanges the purchased fixed exchange rate money for cash and deposits in the seller's bank account. In other words, the cash exchange unit 240 deducts the fixed exchange rate money saved in the seller wallets (C3 and C4) and transfers cash equivalent to the deducted fixed exchange rate money to the seller's account.

As an example, under the circumstance that the exchange rate between cash and the fixed exchange rate money is 1:10, when the seller exchanges 500TOSP for cash, the seller terminal 110 sends a selling request signal to the cash exchange unit 240 based on the seller's input. The cash exchange unit 240 deducts 500TOSP saved in the seller wallets (C3 and C4) and sends cash of KRY 5,000 won to the seller's account on the basis of the selling request signal of the seller terminal.

In this instance, the exchange request unit 230 may change the exchange rate between the floating exchange rate money and the fixed exchange rate money based on the manager's input or periodically. However, if the exchange request unit 230 suddenly changes the exchange rate, the sellers who hold the fixed exchange rate money suffer unexpected damages. So, the sellers must sell the fixed exchange rate money that the sellers hold before change of the exchange rate when the exchange request unit 230 changes the exchange rate.

Therefore, the cash exchange unit 240 of the payment system using virtual money according to the embodiment of the present invention can exchange the fixed exchange rate money which exists in the seller wallets (C3 and C4) for cash before a predetermined period of time from the change time of the exchange rate and can send the cash to the seller's account.

As an example, when the exchange request unit 230 changes the exchange rate between the fixed exchange rate money and cash once a month, the cash exchange unit 240 deducts all of the fixed exchange rate money saved in the seller's account and sends cash equivalent to the amount of the fixed exchange rate money to the seller's account on a predetermined date before the date of changing the exchange rate every month.

Hereinafter, the principle that the fixed exchange rate money and the floating exchange rate money of various kinds are saved in the buyer wallets (C1 and C2) and the seller wallets (C3 and C4) through a plurality of the exchange servers 300 will be described.

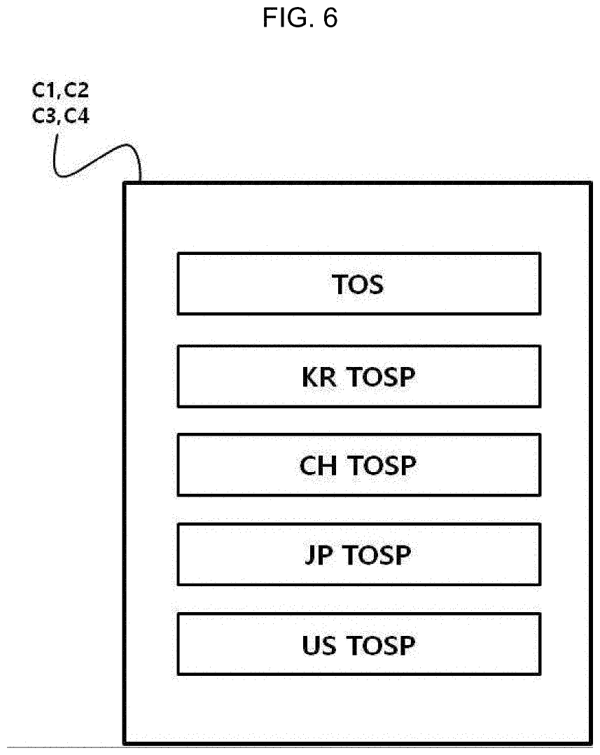

FIG. 6 is a view showing the principle that the floating exchange rate money and the fixed exchange rate money exchanged through the plurality of exchange servers are displayed through the buyer wallets and user wallets.

The exchange servers 300 may be arranged in predetermined countries or regions.

In detail, the fixed exchange rate money may be determined differently by specific countries. For instance, there may be Korean fixed exchange rate money (hereinafter, called KSTOSP) in Korea, Chinese fixed exchange rate money (hereinafter, called CHTOSP) in China, Japanese fixed exchange rate money (hereinafter, called JPTOSP) in Japan, and U.S. fixed exchange rate money (hereinafter, called USTOSP) in U.S.

The exchange servers 300 may exchange the floating exchange rate money for different KSTOSP.

A Korean exchange server 300KR exchanges TOS for KSTOSP, a Chinese exchange server 300CH exchanges TOS for CHTOSP, a Japanese exchange server 300JP exchanges TOS for JPTOSP, and an U.S. exchange server 300US exchanges TOS for USTOSP.

In more detail, countries or specific regions, for instance, self-government regions like Hong Kong, have independent money systems, and the exchange rate between currencies is determined among different countries or regions. If a person travels to a foreign country, the person has to exchange his money for money of the corresponding country. In this instance, the person must provide a bank with commission for money exchange, and in this instance, there may be a limitation by the Foreign Exchange Control Law.

However, according to the embodiment of the present invention, the traveler can buy TOS using his or her money and exchange the purchased TOS for TOSP (fixed exchange rate money) of the specific country in order to use it in the corresponding country. In this instance, there is no commission for money exchange and TOS serves as a key currency.

The above description is only exemplary, and it will be understood by those skilled in the art that the invention may be embodied in other concrete forms without changing the technological scope and essential features. Therefore, the above-described embodiments should be considered only as examples in all aspects and not for purposes of limitation. For example, each component described as a single type may be realized in a distributed manner, and similarly, components that are described as being distributed may be realized in a coupled manner.

It would be appreciated that the scope of the present invention is defined by the appended claims, and encompasses all modifications or alterations derived from meanings, the scope and equivalents of the appended claims.

1. A payment system using virtual money comprising:
a transaction server for managing fixed exchange rate money which is virtual money with an exchange rate fixed against cash and floating exchange rate money which is virtual money with an exchange rate continuously changing against cash; and
an exchange server for exchanging the floating exchange rate money for the fixed exchange rate money.

2. The payment system according to claim 1, wherein the transaction server comprises:
a virtual money purchasing unit which receives a purchase request signal including kinds and amounts of virtual money to be purchased from a buyer terminal and buys the floating exchange rate money from a virtual currency exchange according to a predetermined purchase request signal;
a virtual money managing unit for saving and managing the floating exchange rate money and the fixed exchange rate money that a user holds in buyer wallets; and
an exchange request unit for receiving an exchange request signal including a desired exchange amount from user terminals and transferring the received exchange request to the exchange server in order to broke exchange.

3. The payment system according to claim 2, wherein the exchange server comprises:
a virtual money exchanging unit which receives an exchange request signal from the transaction server and exchanges the floating exchange rate money for the fixed exchange rate money on the basis of an amount included in the exchange request signal;
a virtual money transfer unit for transferring the fixed exchange rate money exchanged by the virtual money exchanging unit to the virtual money managing unit; and
an exchange rate decision unit which receives an exchange rate between the floating exchange rate money and the fixed exchange rate money.

4. The payment system according to claim 3, wherein the exchange rate decision unit receives the exchange rate between the floating exchange rate money and the fixed exchange rate money every predetermined cycle.

5. The payment system according to claim 4, wherein the exchange rate decision unit determines the exchange rate between the floating exchange rate money and the fixed exchange rate money in link with the exchange rate between the floating exchange rate money and cash.

6. The payment system according to claim 5, wherein the cash exchange unit exchanges the fixed exchange rate money which exists in the seller wallets for cash before a predetermined period of time from the change time of the exchange rate and sends the cash to the seller's account.

7. The payment system according to claim 6, further comprising a plurality of exchange servers,
wherein the exchange servers exchange the floating exchange rate money for different fixed exchange rate currencies.
